(19) United States
(12) Patent Application Publication
(10) Pub. No.: US 2005/0159975 A1
(43) Pub. Date: Jul. 21, 2005

(54) Multiple-party business cooperation system and method

(76) Inventors: JianDong Wang, Shenzhen (CN); Bin Li, Shenzhen (CN)

Correspondence Address: WEI TE CHUNG;FOXCONN INTERNATIONAL, INC., 1650 MEMOREX DRIVE, SANTA CLARA, CA, 95050, US

(21) Appl. No.: 11/038,555

(22) Filed: Jan. 18, 2005

(30) Foreign Application Priority Data
Jan. 16, 2004 (TW) 93101197

(51) Int. Cl. G06F 17/60

(52) U.S. Cl. 705/1; 705/28

(57) ABSTRACT

A multiple-party business cooperation system for exchanging business data includes a business-to-business application server (10), a database (11), a number of manufacturer sub-systems (12), a number of brand maker sub-systems (13), and a number of forwarder sub-systems (14). The business-to-business application server includes a receiving module (100) for receiving the business data, a translating module (101) for translating the business data into documents in a designated format, a transmitting module (102) for transmitting the documents to corresponding sub-systems, and a storing module (103) for storing the documents in the database. A related multiple-party business cooperation method is also provided.

### BACKGROUND OF THE INVENTION

1. Field of the Invention

The present invention relates to computerized data processing systems and methods, and particularly to a data processing system and method for business cooperation between various parties.

2. Background of the Invention

Many businesses have become dependent on so-called “distributed” systems for accessing, storing and processing data generated by or required by the business. The components which are accessed using the client may be part of the businesses' network or they may be components operated by affiliated or unaffiliated third parties. Electronic Data Interchange (EDI) allows businesses to exchange many kinds of data with each other electronically. EDI is the direct exchange (application to application) transmission of business documents such as purchase orders, invoices and remittance advices. Businesses fully engaged in electronic commerce have found that EDI conveniently extracts information from an application, for example an accounting or inventory management program, and transmits the information via telephone lines and/or other communications paths. At the receiving end, the data can be fed directly into a computer system and automatically processed and interfaced with internal applications of that system with a minimum of user intervention. EDI typically requires a computer, EDI management and translation software, communications hardware and software, and a communication medium. The EDI management software extracts outgoing data from and inserts incoming data into an internal application. That is, EDI management software translates application specific data into data in an EDI standard format, and data in an EDI standard format into application specific data. The EDI standard format is a message format which regulates the syntax, structure and content of the EDI data, and which is used to create computer-readable versions of paper documents.

Current systems using EDI for exchanging data among businesses perform the data exchange either over a direct connection between the business partners or via a value-added network (VAN). However, maintaining a direct connection between business partners or configuring a VAN is expensive, because a dedicated line is maintained between the partners and because the operation capability of the VAN fluctuates according to the scope of the VAN. Accordingly, there is a need for an inexpensive system and method for exchanging data among the businesses which can overcome the above-mentioned problems.

### SUMMARY OF THE INIVENTION

A main objective of the present invention is to provide a multiple-party business cooperation system and method which can efficiently exchange business data in a designated format.

To accomplish the above objective, a multiple-party business cooperation system in accordance with a preferred embodiment of the present invention comprises a business-to-business application server, a database, a plurality of manufacturer sub-systems, a plurality of brand maker sub-systems, and a plurality of forwarder sub-systems. The business-to-business application server is connected to the manufacturer sub-systems, the brand maker sub-systems and the forwarder sub-systems through a network, and is connected to the database via a database connection.

The business-to-business application server is used for receiving and transmitting business data. The business data include production forecasting reports, daily invoices, daily inventory reports, weekly payment notifications, and all kinds of shipment notifications and responses.

The business-to-business application server comprises a translating module, a transmitting module, and a storing module. The translating module is used for translating the business data into documents in a RosettaNet format. The transmitting module is used for transmitting the documents to the various sub-systems according to information specified in the documents. The storing module is used for storing the documents in the database.

Further, the present invention provides a multiple-party business cooperation method, the method comprising the steps of: (a) receiving production forecasting reports from a brand maker sub-system; (b) transmitting the production forecasting reports to corresponding manufacturer sub-systems; (c) receiving responses from the manufacturer sub-systems, and transmitting the responses from the manufacturer sub-systems to the brand maker sub-system; (d) receiving shipment notifications from the manufacturer sub-systems, and transmitting the shipment notifications from the manufacturer sub-systems to corresponding forwarder sub-systems; (e) receiving responses from the forwarder sub-systems, and transmitting the responses from the forwarder sub-systems to the manufacturer sub-systems; (f) receiving daily inventory reports from the forwarder sub-systems, and transmitting the daily inventory reports to the manufacturer sub-systems; (g) receiving shipment notifications from the forwarder sub-systems, and transmitting the shipment notifications from the forwarder sub-systems to the manufacturer sub-systems; (h) receiving daily invoices from the brand maker sub-system, and transmitting the daily invoices to the manufacturer sub-systems; and (i) receiving weekly payment notifications from the brand maker sub-system, and transmitting the payment notifications to the manufacturer sub-systems.

Other objects, advantages and novel features of the present invention will be drawn from the following detailed description with reference to the attached drawings, in which:

### BRIEF DESCRIPTION OF THE DRAWINGS

FIG. 1 is a schematic diagram of hardware infrastructure of a multiple-party business cooperation system in accordance with the preferred embodiment of the present invention;

FIG. 2 is a schematic diagram illustrating data flow between a B2B application server and a database and various sub-systems of the system of FIG. 1;

FIG. 3 is a schematic diagram of main function modules of the B2B application server of the system of FIG. 1;

FIG. 4 is a flowchart of a preferred method for processing business data received from various parties by the B2B application server according to the present invention; and

FIG. 5 is a flowchart of a preferred method for implementing the system of FIG. 1.

### DETAILED DESCRIPTION OF THE INVENTION

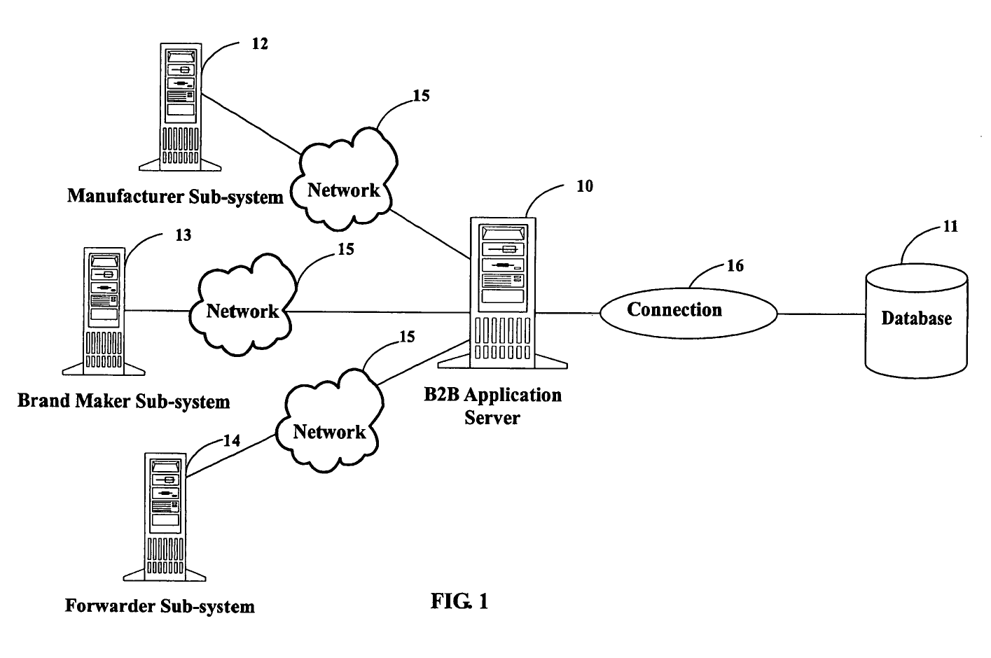

FIG. 1 is a schematic diagram of hardware infrastructure of a multiple-party business cooperation system (hereinafter, “the system”) in accordance with the preferred embodiment of the present invention. The system comprises a business-to-business (B2B) application server 10, a database 11, a plurality of manufacturer sub-systems 12 (only one shown), a plurality of brand maker sub-systems 13 (only one shown), and a plurality of forwarder sub-systems 14 (only one shown). The B2B application server 10 is connected to the manufacturer sub-systems 12, the brand maker sub-systems 13 and the forwarder sub-systems 14 through a network 15, and is connected to the database 11 through a database connection 16. The B2B application server 10 receives business data from the sub-systems 12, 13, 14, translates the business data into documents in a designated format, stores the documents in the database 11, and transmits the documents to the sub-systems 12, 13, 14. The network 15 may be an intranet, the Internet, or any other suitable type of communications network. The database connection 16 is a database connectivity such as an ODBC (Open Database Connectivity) or a JDBC (Java Database Connectivity).

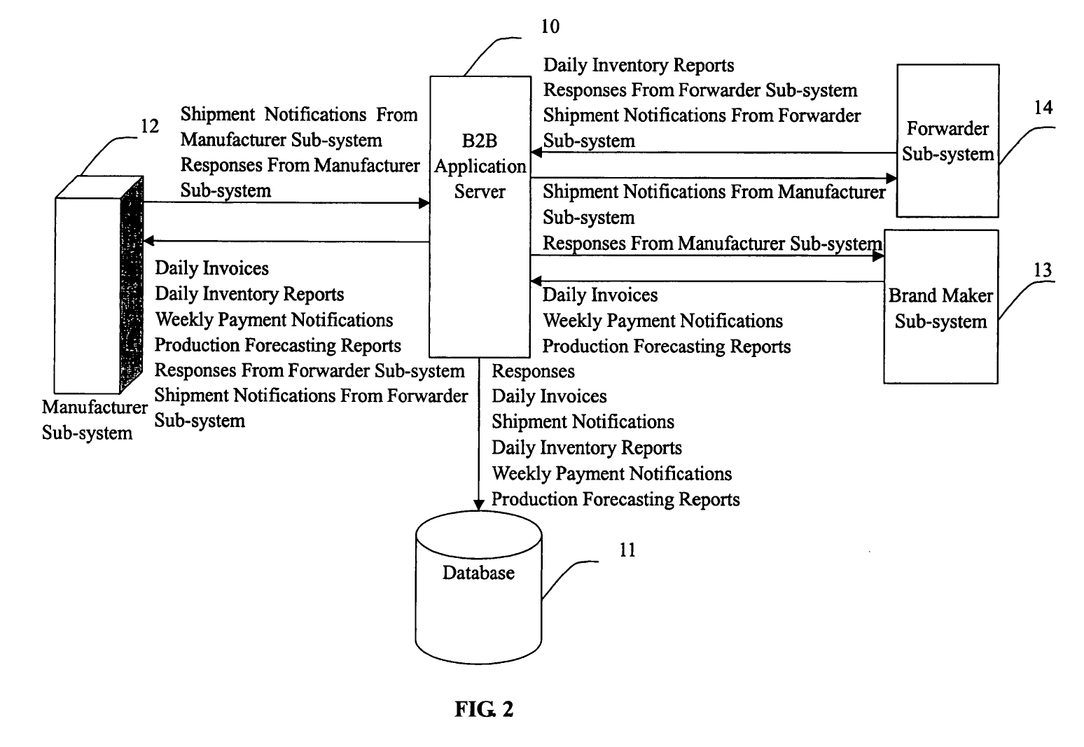

FIG. 2 is a schematic diagram illustrating data flow between the B2B application server 10 and the database 11 and one of each of the sub-systems 12, 13, 14. The B2B application server 10 receives and transmits business data from and to the manufacturer sub-system 12, the brand maker sub-system 13, and the forwarder sub-system 14. The business data includes production forecasting reports, daily invoices, daily inventory reports, weekly payment notifications, and all kinds of shipment notifications and responses. The B2B application server 10 stores the business data in the database 11.

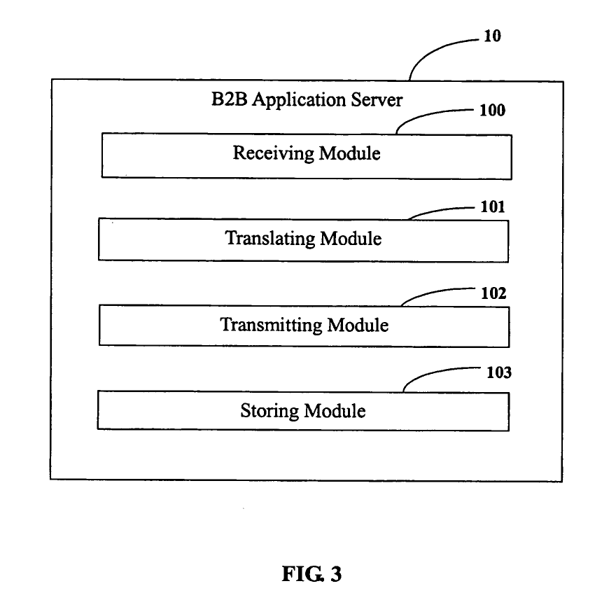

FIG. 3 is a schematic diagram of main function modules of the B2B application server 10. The B2B application server 10 comprises a receiving module 100, a translating module 101, a transmitting module 102, and a storing module 103. The receiving module 100 receives business data from the manufacturer sub-system 12, the brand maker sub-system 13, and the forwarder sub-system 14. The translating module 101 translates the business data into RosettaNet format documents. The transmitting module 102 transmits the RosettaNet format documents to corresponding sub-systems 12, 13, 14. The storing module 103 stores the RosettaNet format documents in the database 11.

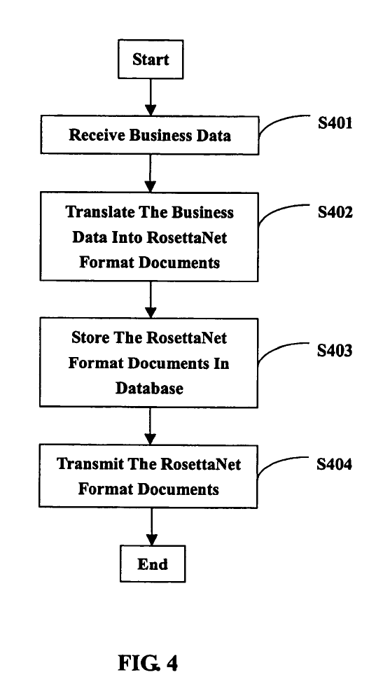

FIG. 4 is a flowchart of a preferred method for processing business data received from various parties by the B2B application server 10 according to the present invention. In step S401, the B2B application server 10 receives business data from the sub-systems 12, 13, 14. In step S402, the B2B application server 10 translates the business data into corresponding RosettaNet format documents. In step S403, the B2B application server 10 stores the RosettaNet format documents in the database 11. In step S404, the B2B application server 10 transmits the RosettaNet format documents to corresponding sub-systems 12, 13, 14 according to information specified in the RosettaNet format documents.

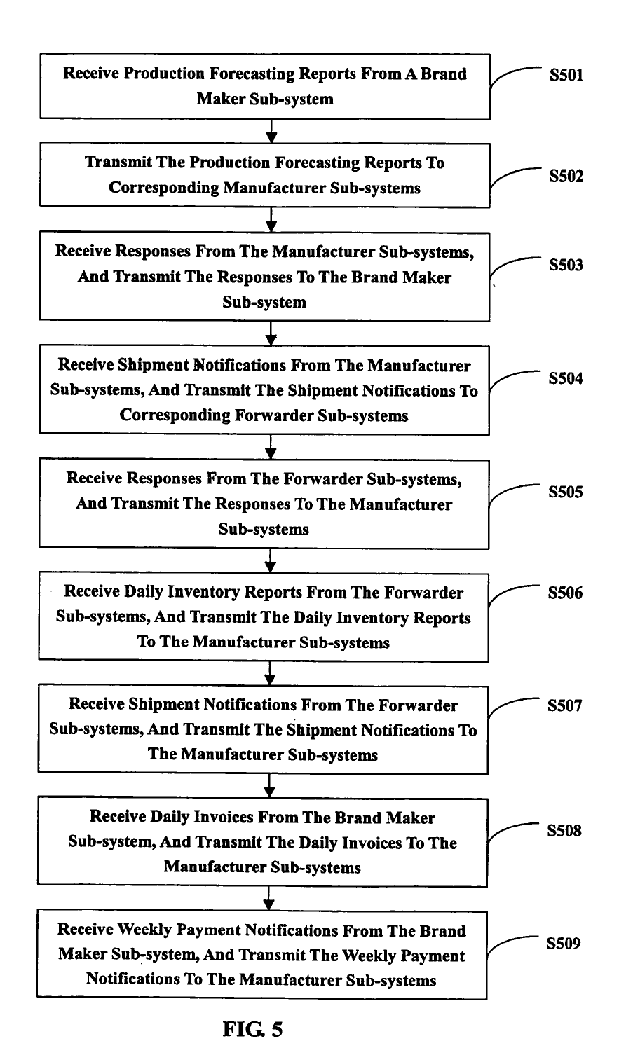

FIG. 5 is a flowchart of a preferred method for implementing the system of FIG. 1. In step S501, the B2B application server 10 receives production forecasting reports from a brand maker sub-system 13. In step S502, the B2B application server 10 transmits the production forecasting reports in RosettaNet format to corresponding manufacturer sub-systems 12. In step S503, the B2B application server 10 receives responses from the manufacturer sub-systems 12 corresponding to the production forecasting reports, and transmits the responses from the manufacturer sub-systems 12 in RosettaNet format to the brand maker sub-system 13. In step S504, the B2B application server 10 receives shipment notifications from the manufacturer sub-systems 12, and transmits the shipment notifications from the manufacturer sub-systems 12 in RosettaNet format to corresponding forwarder sub-systems 14. In step S505, the B2B application server 10 receives responses from the forwarder sub-systems 14 corresponding to the shipment notifications from the manufacturer sub-systems 12, and transmits the responses from the forwarder sub-systems 14 in RosettaNet format to the manufacturer sub-systems 12. In step S506, the B2B application server 10 receives daily inventory reports from the forwarder sub-systems 14, and transmits the daily inventory reports in RosettaNet format to the manufacturer sub-systems 12. In step S507, the B2B application server 10 receives shipment notifications from the forwarder sub-systems 14, and transmits the shipment notifications from the forwarder sub-systems 14 in RosettaNet format to the manufacturer sub-systems 12. In step S508, the B2B application server 10 receives daily invoices from the brand maker sub-system 13, and transmits the daily invoices in RosettaNet format to the manufacturer sub-systems 12. In step S509, the B2B application server 10 receives weekly payment notifications from the brand maker sub-system 13, and transmits the weekly payment notifications in RosettaNet format to the manufacturer sub-systems 12.

Although the present invention has been specifically described on the basis of a preferred embodiment and preferred methods, the invention is not to be construed as being limited thereto. Various changes or modifications may be made to the embodiment and methods without departing from the scope and spirit of the invention.

1. A multiple-party business cooperation system for exchanging business data, comprising:
a database;
a business-to-business application server, which is connected to a plurality of manufacturer sub-systems, a plurality of brand maker sub-systems, and a plurality of forwarder sub-systems, for receiving, translating, storing and transmitting the business data, and which comprises:
a receiving module for receiving the business data;
a translating module for translating the business data into designated format documents;
a transmitting module for transmitting the documents to corresponding sub-systems; and
a storing module for storing the documents in the database.

2. The multiple-party business cooperation system according to claim 1, wherein the designated format is RosettaNet format.

3. The multiple-party business cooperation system according to claim 1, wherein the business data include production forecasting reports, daily invoices, weekly payment notifications, daily inventory reports, responses, and shipment notifications.

4. A computer-based method for processing business data obtained from multiple business parties, the method comprising the steps of:
receiving the business data from one or more of said business parties;
translating the business data into documents in a designated format;
storing the documents in a database; and
transmitting the documents to one or more corresponding business parties according to information specified in the documents.

5. The method according to claim 4, wherein the designated format is RosettaNet format.

6. A computer-enabled multiple-party business cooperation method for exchanging business data, the method comprising the steps of:
receiving production forecasting reports from a brand maker sub-system;
transmitting the production forecasting reports to corresponding manufacturer sub-systems;
receiving responses from the manufacturer sub-systems, and transmitting the responses to the brand maker sub-system;
receiving shipment notifications from the manufacturer sub-systems, and transmitting the shipment notifications to corresponding forwarder sub-systems;
receiving responses from the forwarder sub-systems, and transmitting the responses to the manufacturer sub-systems;
receiving daily inventory reports from the forwarder sub-systems, and transmitting the daily inventory reports to the manufacturer sub-systems;
receiving shipment notifications from the forwarder sub-systems, and transmitting the shipment notifications to the manufacturer sub-systems;
receiving daily invoices from the brand maker sub-system, and transmitting the daily invoices to the manufacturer sub-systems; and
receiving weekly payment notifications from the brand maker sub-system, and transmitting the weekly payment notifications to the manufacturer sub-systems.
